(19) United States
(12) Patent Application Publication
(10) Pub. No.: US 2010/0181895 A1
(43) Pub. Date: Jul. 22, 2010

(54) LUMINOUS TUBE, FLUORESCENT LAMP, AND LUMINOUS TUBE PRODUCTION METHOD

(76) Inventor: KOJI NOMURA, Tokyo (JP)

Correspondence Address: Mr. Jackson Chen, 6535 N. STATE HWY 161, IRVING, TX, 75039, US

(21) Appl. No.: 12/687,741

(22) Filed: Jan. 14, 2010

(30) Foreign Application Priority Data
Jan. 22, 2009 (JP) 2009-012396

(51) Int. Cl. H01J 1/62; H01J 9/00

(52) U.S. Cl. 313/493; 445/22

(57) ABSTRACT

A luminous tube, a fluorescent lamp, and a luminous tube production method in which a larger quantity of light is emitted downward in actual use of the fluorescent lamp are provided. The luminous tube includes a glass tube including a folded structure where the glass tube is a spiral from at least one of the ends to a middle part and a fluorescent film on the inner surface thereof, wherein the fluorescent film on the inner surface is thicker on the side closer to the middle part than on the side closer to the ends in a cross-section along the axis of the spiral at any point of the glass tube.

### INCORPORATION BY REFERENCE

This application is based on the Japanese Patent Application No. 2009-012396 filed on Jan. 22, 2009 and including specification, claims, drawings and summary. The disclosure of the above Japanese Patent Application is incorporated herein by reference in its entirety.

### TECHNICAL FIELD

The present disclosure relates to a luminous tube, a fluorescent lamp, and a luminous tube production method.

### BACKGROUND ART

Having high lamp efficiency and long life, compact fluorescent lamps have become widely used as a light source replacing incandescent bulbs. Fluorescent lamps have a luminous tube on an inner surface of which a fluorescent film is formed.

Compact fluorescent lamps are required to be nearly equal in size to incandescent bulbs. Therefore, for incorporation in a limited space and brighter illumination, U-shaped or double-spiral luminous tubes are used for extended tube lengths. Such luminous tubes are described, for example, in Japanese Patent Application KOKAI Publication Nos. 2008-059947 and S61-091824.

Generally, a fluorescent film is formed on the inner surface of a luminous tube by the method disclosed in the Japanese Patent Application KOKAI Publication No. S61-091824. The fluorescent film in a fluorescent tube is formed as follows. First, a phosphor solution for forming a fluorescent film is injected through a branch tube provided at the head of a U-shaped glass tube and discharged. Then, the glass tube is placed upright with both openings facing downward and warm air is introduced through the branch tube to dry the phosphor solution and form the fluorescent film.

Japanese Patent Application KOKAI Publication No. S61-091824 discloses the above method of forming a fluorescent film in a U-shaped luminous tube. However, the same method can be applied to the formation of a fluorescent film in a double-spiral luminous tube.

In the above luminous tube, the glass tube is dried with the openings, where the electrodes are provided, facing downward. The phosphor solution drifts downward and shifts to the openings because of its own weight during drying. Therefore, the luminous tube has a fluorescent film that is thinner in the top part.

In general use, compact fluorescent lamps are mounted on a ceiling and the like to illuminate downward. Then, the head part of the luminous tube faces downward. Light is emitted through the thickness of the fluorescent film on the inner surface of the luminous tube. The quantity of light increases where the fluorescent film is thicker. The above luminous tube has a fluorescent film that is thinner in the head part facing downward in use. Therefore, a smaller quantity of light is emitted downward.

### SUMMARY

The present disclosure is made in view of the above circumstances and an exemplary object of the present disclosure is to provide a luminous tube, a fluorescent lamp, and a luminous tube production method in which a larger quantity of light is emitted in a desired direction of illumination in actual use.

A luminous tube according to a first exemplary aspect of the present disclosure is preferably a luminous tube including a glass tube in a folded structure where the glass tube is a spiral from at least one of its ends to a middle part thereof, the glass tube including a fluorescent film on the inner surface thereof, wherein the fluorescent film on the inner surface is thicker on the side closer to the middle part than on the side closer to the ends in a cross-section along the axis of the spiral at any point of the glass tube.

A fluorescent lamp according to a second exemplary aspect of the present disclosure preferably includes the luminous tube according to the first exemplary aspect of the present disclosure.

A luminous tube production method according to a third exemplary aspect of the present disclosure preferably includes the following steps: preparing a glass tube opening at both ends, including a folded structure where the glass tube is a spiral in at least one of portions between ends and a middle part, and provided with a discharge tube protruding outward and communicating with the interior at the middle part; injecting a phosphor solution into the glass tube from the ends; discharging the injected phosphor solution from the discharge tube; and drying the phosphor solution while the glass tube is maintained upright with the discharge tube facing downward.

### BRIEF DESCRIPTION OF THE DRAWINGS

FIG. 1 is a partially cross-sectional view showing the structure of a luminous tube according to an embodiment of the present disclosure.

FIG. 2 is a cross-sectional view showing the structure of the discharge tube according to an embodiment of the present disclosure.

FIG. 3 is a partially cross-sectional view showing the structure of a fluorescent lamp according to an embodiment of the present disclosure.

FIG. 4 is an illustration showing the luminous tube production method according to an embodiment of the present disclosure.

FIG. 5 is an illustration showing the luminous tube production method according to an embodiment of the present disclosure.

FIG. 6 is an illustration showing the luminous tube production method according to an embodiment of the present disclosure.

### EXEMPLARY EMBODIMENTS

A luminous tube, a fluorescent lamp, and a luminous tube production method according to embodiments of the present disclosure are described in detail hereafter with reference to the drawings. The same or corresponding parts are referred to by the same reference numbers in the drawings.

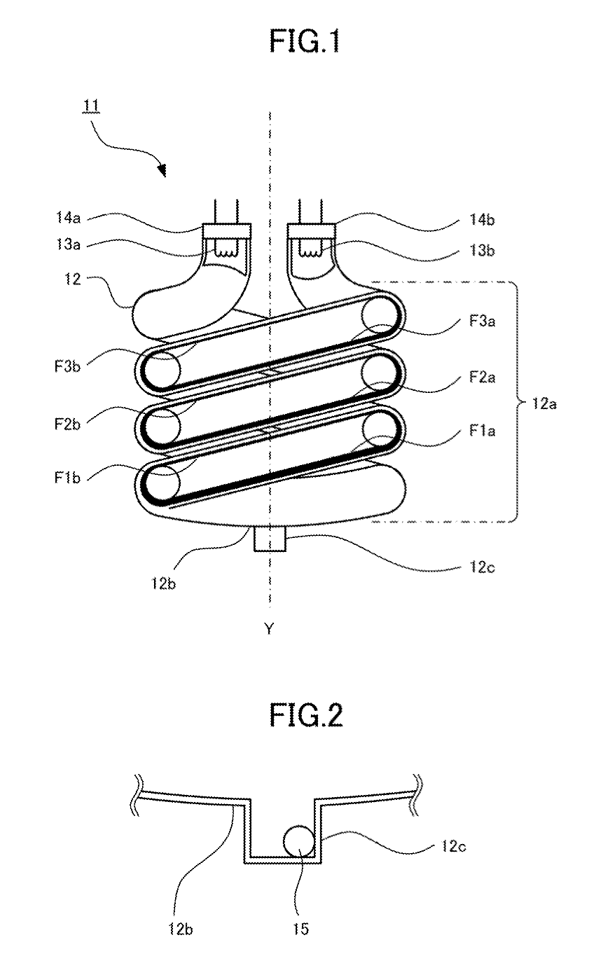

As shown in the partially cross-sectional view of FIG. 1, a luminous tube 11 is mainly composed of a glass tube 12, filaments 13a and 13b provided at the ends 14a and 14b, respectively, and a fluorescent film F.

The glass tube 12 has a so-called double-spiral structure folded at middle part 12b neatly at the center thereof and having a spiral part 12a where the glass tube between the middle part 12b and the ends 14a and 14b spiral about a spiral axis Y. The glass tube 12 is filled with a buffer gas, such as argon, krypton, etc. serving as a discharging medium.

Here, the glass tube 12 is not necessarily a double-spiral. All that is required is that the glass tube 12 is folded as a whole with the ends 14a and 14b being substantially adjacent to each other and oriented nearly in the same direction. For example the lengths from the middle part to either end are not necessarily equal such as in the case where the glass tube is linear from one end to the middle part and spirals from the middle part to the other end.

The glass tube 12 has a fluorescent film F formed on the entire inner surface thereof. The fluorescent film F is a fluorescent film having three emission wavelength bands containing a phosphor emitting red light, a phosphor emitting green light, and a phosphor emitting blue light.

More specifically, the fluorescent film F is composed of a phosphor containing europium-induced yttrium oxide and emitting red light, a phosphor containing terbium or cerium-induced lanthanum phosphate and emitting green light, and a phosphor containing one or more species selected from europium-induced barium magnesium aluminate, europium-induced strontium chlorophosphate, europium-induced calcium chlorophosphate, and europium-induced barium chlorophosphate and emitting blue light.

The fluorescent film F has different thicknesses in any cross-section of the spiral part 12a of the glass tube 12. More specifically, when seen in a cross-section of the spiral part 12a of the glass tube 12 at any point along the spiral axis Y, the middle part side fluorescent film F1a, F2a, and F3a on the side closer to the middle part 12b are thicker than the end part side fluorescent film F1b, F2b, and F3b on the side closer to the ends 14a and 14b.

In each cross-section of the spiral part 12a satisfies the following relationship: the thickness of the middle part side fluorescent film F1a> the end part side fluorescent film F1b, the middle part side fluorescent film F2a> the end part side fluorescent film F2b, and the middle part side fluorescent film F3a> the end part side fluorescent film F3b.

Furthermore, the middle part side fluorescent film F1a, F2a, and F3a formed on the inner surface of the spiral part 12a on the side closer to the middle part 12b have a gradually increasing thickness from the ends 14a and 14b to the middle part 12b. Consequently, the thickness of the fluorescent film formed on the side closer to the middle part 12b satisfies the following relationship: the middle part side fluorescent film F1a> the middle part side fluorescent film F2a>the middle part side fluorescent film F3a.

A discharge tube 12c communicating with the interior of the glass tube 12 and protruding outward is provided at the middle part 12b of the glass tube 12. As shown in FIG. 2, the discharge tube 12c is closed at the end and mercury amalgam 15 is placed in the discharge tube 12c.

When the luminous tube 11 having the above structure is turned on and voltage is applied to the filaments 13a and 13b, electric discharge occurs. The filaments 13a and 13b produce heat and the heat causes the mercury amalgam 15 to release mercury vapor.

Electrons released by the electric discharge collide with mercury vapor (mercury atoms) and the mercury atoms receive energy from the electrons upon collision and produce ultraviolet rays. The fluorescent film F formed on the inner wall of the glass tube 12 receives the ultraviolet ray and produces visible rays (light).

The above luminous tube 11 is used as a compact fluorescent lamp. The compact fluorescent lamp is generally mounted on a ceiling to illuminate downward. Therefore, it is mounted with the middle part 12b of the luminous tube 11 facing downward (in the desired direction of illumination).

The luminous tube 11 emits light along the thickness of the fluorescent film F formed on the inner surface thereof. Generally, the quantity of light increases where the fluorescent film F is thicker. In the above luminous tube 11, the middle part side fluorescent film F1a, F1a, and F3a formed on the side closer to the middle part 12b and facing downward in use are thicker. Therefore, luminous tube 11 advantageously emits a larger quantity of light downward compared with a luminous tube having the fluorescent film thicker on the side closer to the ends.

The luminous tube 11 that is the double-spiral as described above has a long discharge channel, which may cause mercury vapor to be short around the middle part 12b where the electric discharge channel is folded when the light is powered on, impairing initial light flux rising properties. However, in this embodiment, the discharge tube 12c is provided at the middle part 12b where the glass tube 12 is folded and the mercury amalgam 15 having the comparable capability of releasing mercury vapor to purified mercury is placed in the discharge tube 12c. Therefore, mercury vapor is immediately released from the mercury amalgam 15 and spreads around the middle part 12b of the glass tube 12. For this reason, the light flux rising properties upon power-on is not reduced even though no supplementary amalgam for improving the light flux rising properties upon power-on is provided in the discharge tube 12c.

The mercury amalgam 15 is spaced from the electric discharge channel. Therefore, the mercury vapor pressure in the glass tube 12 does not unnecessarily rise, preventing cut-down in light emission efficiency while the light is on.

Purified mercury can be used in place of the mercury amalgam 15.

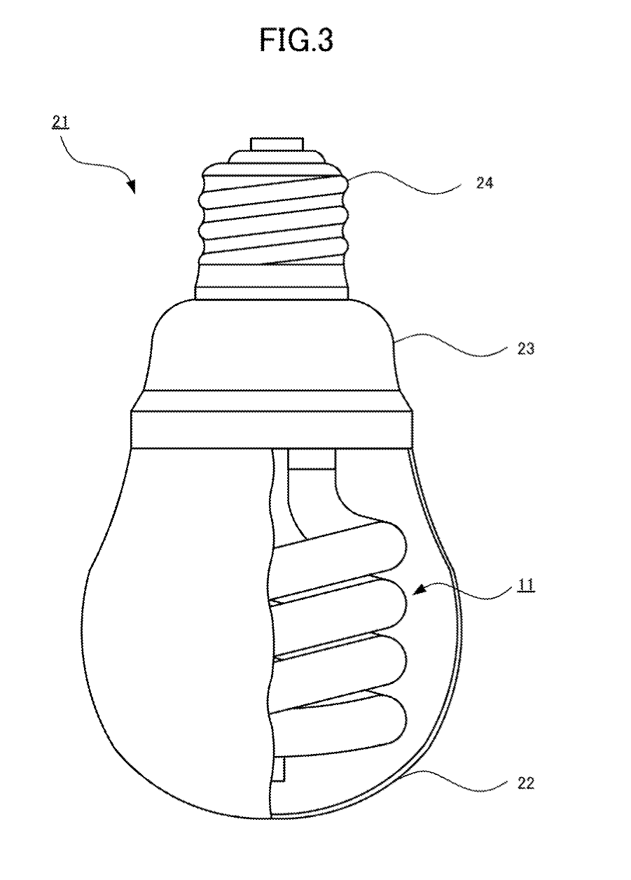

As shown in FIG. 3, the fluorescent lamp 21 is composed of a luminous tube 11, a globe 22, a cover 23, and a base 24.

The luminous tube 11 has the same structure as described above and will not be explained here.

The globe 22 is made of a heat-resistant material such as colorless or light-diffusing glass and synthetic resin and similar in shape to the glass globe of general light bulbs such as incandescent light bulbs. Attached to the cover 23, the globe 22 encloses the luminous tube 11 to protect it and equalizes the light emitted by the luminous tube 11.

The cover 23 is made of a heat-resistant synthetic resin, etc. and covers an un-shown lighting circuit and the like.

The base 24 is attached to the cover 23. The base 24 has a spiral groove formed at outer periphery thereof and detachably connected to a socket of an un-shown lighting equipment body by means of the groove, to receive necessary power and provide the power to the above mentioned lighting circuit.

The fluorescent lamp 21 contains the above described luminous tube 11 and emits a larger quantity of light downward in use because the middle part 12b of the luminous tube 11 faces downward (in the desired direction of illumination).

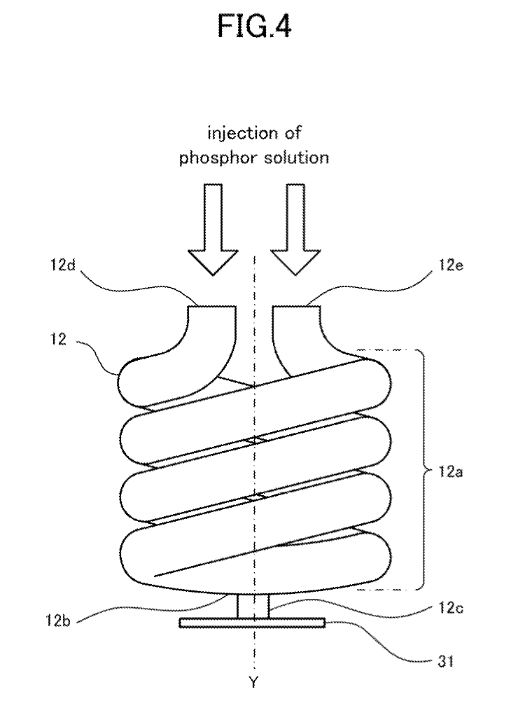

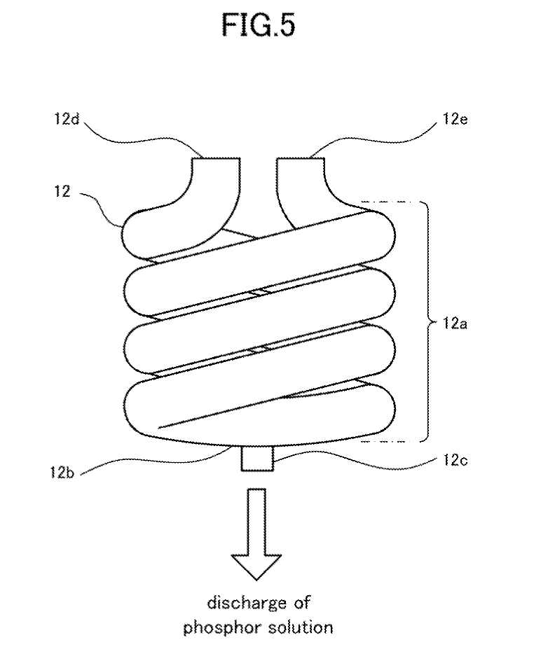

The production method of the luminous tube according to the embodiment is described hereafter with reference to FIGS. 4 to 6.

First, a glass tube 12 having openings 12d and 12e, a spiral part 12a where the glass tube 12 is spiral about a spiral axis Y from a middle part 12b to at least one end, and a discharge tube 12c protruding outward from the middle part 12b and communicating with and opening to the interior is prepared as shown in FIG. 4.

A phosphor solution having three emission wavelength bands is injected in the glass tube 12. The phosphor solution is injected to completely fill the glass tube 12 so that the phosphor solution adheres to the entire inner surface of the glass tube 12.

The phosphor solution is prepared so as to contain a phosphor emitting red light, a phosphor emitting green light, and a phosphor emitting blue light. The phosphor solution is prepared by mixing a phosphor containing europium-induced yttrium oxide and emitting red light, a phosphor containing terbium or cerium-induced lanthanum phosphate and emitting green light, and a phosphor containing one or more species selected from europium-induced barium magnesium aluminate, europium-induced strontium chlorophosphate, europium-induced calcium chlorophosphate, and europium-induced barium chlorophosphate and emitting blue light, with a binder, biding agent, surfactant, and deionized water, and the like.

The phosphor solution is injected in the glass tube 12 maintained upright with the discharge tube 12c facing downward. In other words, with the openings 12d and 12e facing upward and the discharge tube 12c closed with a lid 31, etc. the phosphor solution is injected in the glass tube 12 through the openings 12d and 12e.

Then, as shown in FIG. 5, the phosphor solution is discharged from the glass tube 12. The lid 31 closing the discharge tube 12c is removed while the glass tube 12 is maintained upright with the discharge tube 12c facing downward, by which any extra phosphor solution in the glass tube 12 is discharged through the discharge tube 12c.

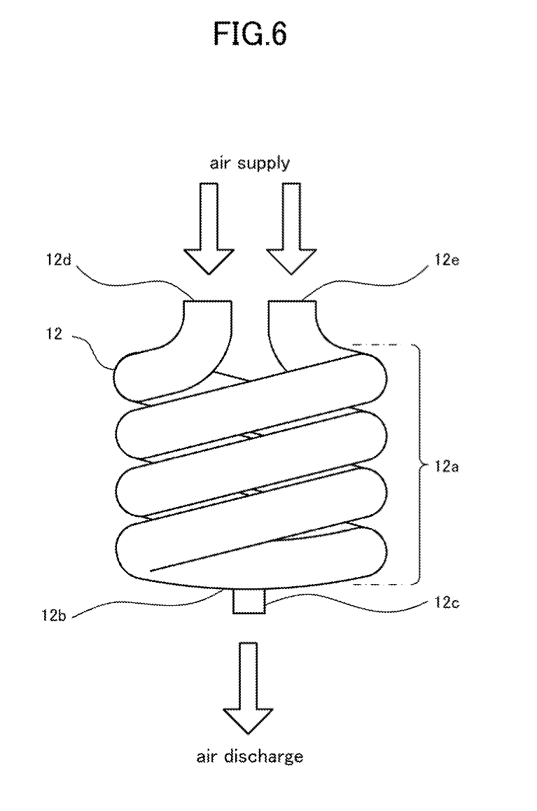

After the phosphor solution is discharged, the phosphor solution adhering to the inner surface of the glass tube 12 is dried as shown in FIG. 6. While drying, the glass tube 12 is maintained upright with the discharge tube 12c facing downward. The phosphor solution is flowable and therefore drifts downward along the inner surface of the glass tube 12 because of its own weight while drying, by which a fluorescent film F is formed on the inner surface of the glass tube 12. In this way, the fluorescent film F becomes thicker on the side closer to the middle part 12b in the lower part. Furthermore, in the spiral part 12a, the fluorescent film F has a gradually increasing thickness on the side closer to the middle part 12b from the openings 12d and 12e.

Preferably, warm or hot air is introduced in the glass tube 12 through the openings 12d and 12e and discharged through the discharge tube 12c while drying. In this way, the phosphor solution is dried in a short time. In addition, unlike in natural drying, the phosphor solution may not drift down before it is dried and the glass tube 12 may have a fluorescent film F in the upper part.

After the fluorescent film F is formed on the inner surface of the glass tube 12, it is fired while air or oxygen is introduced in the glass tube 12 to remove any contaminants adhering to the fluorescent film F.

Then, mercury amalgam 15 or purified mercury is fixed inside the discharge tube 12c before the discharge tube 12c is sealed. Purified mercury and the like can be introduced directly in the discharge tube 12c. Alternatively, a mercury pellet can be introduced and treated with high frequencies to release mercury after the discharge tube 12c is sealed.

Then, a buffer gas such as argon is introduced and sealed and filaments are attached in a conventional manner, the process thereof is not explained here.

In the above method, produced the luminous tube 11 has a fluorescent film F that is thicker on the side closer to the middle part 12b than on the side closer to the openings 12d and 12e and has a gradually increasing thickness on the side closest to the middle part 12b from the openings 12d and 12e.

The phosphor solution is injected, discharged, and dried while the glass tube 12 is maintained upright with the discharge tube 12c facing downward. Therefore, there is no need of inverting the glass tube 12, enabling the luminous tube to be produced in a shorter time.

Additionally, preferable modifications of the recent disclosure include the following structures.

The luminous tube according to a first exemplary aspect of the present disclosure is:

preferably, the fluorescent film on the inner surface on the side closer to the ends has an increasing thickness from the ends to the middle part in a cross-section along the axis of the spiral of the glass tube;

preferably, a discharge tube communicating with the interior of the glass tube and protruding outside is provided at the middle part and mercury or mercury amalgam is placed in the discharge tube; and

preferably, the fluorescent film has three emission wavelength bands including a phosphor containing europium-induced yttrium oxide and emitting red light, a phosphor containing terbium or cerium-induced lanthanum phosphate and emitting green light, and a phosphor containing one or more species selected from europium-induced barium magnesium aluminate, europium-induced strontium chlorophosphate, europium-induced calcium chlorophosphate, and europium-induced barium chlorophosphate and emitting blue light.

The luminous tube production method according to a third exemplary aspect of the present disclosure is:

preferably, the phosphor solution injection step is performed while the glass tube is maintained upright with the discharge tube facing downward; and

preferably, the phosphor solution drying step is performed while air is introduced into the glass tube from the ends and discharged from the discharge tube.

What is claimed is:

1. A luminous tube comprising a glass tube including a folded structure where said glass tube is a spiral from at least one of its ends to a middle part thereof, the glass tube including, a fluorescent film on the inner surface thereof, wherein:
said fluorescent film on the inner surface is thicker on the side closer to said middle part than on the side closer to said ends in a cross-section along the axis of said spiral at any point of said glass tube.

2. The luminous tube according to claim 1, wherein said fluorescent film on the inner surface on the side closer to said ends has an increasing thickness from said ends to said middle part in a cross-section along the axis of said spiral of said glass tube.

3. The luminous tube according to claim 1, wherein a discharge tube communicating with the interior of said glass tube and protruding outward is provided at said middle part and mercury or mercury amalgam is placed in said discharge tube.

4. The luminous tube according to claim 1, wherein said fluorescent film is a fluorescent film comprising three emission wavelength bands including a phosphor containing europium-induced yttrium oxide and emitting red light, a phosphor containing terbium or cerium-induced lanthanum phosphate and emitting green light, and a phosphor containing one or more species selected from europium-induced barium magnesium aluminate, europium-induced strontium chlorophosphate, europium-induced calcium chlorophosphate, and europium-induced barium chlorophosphate and emitting blue light.

5. A fluorescent lamp comprising the luminous tube according to claim 1.

6. A luminous tube production method comprising the steps of:
preparing a glass tube opening at both ends, including a folded structure where said glass tube is a spiral in at least one of the portions between the ends and a middle part, and provided with a discharge tube protruding outward and communicating with the interior at said middle part;
injecting a phosphor solution into said glass tube from said ends;
discharging said injected phosphor solution from said discharge tube; and
drying said phosphor solution while said glass tube is maintained upright with said discharge tube facing downward.

7. The luminous tube production method according to claim 6, wherein said step of injecting a phosphor solution is performed while said glass tube is maintained upright with said discharge tube facing downward.

8. The luminous tube production method according to claim 6, wherein said step of drying a phosphor solution is performed while air is introduced into said glass tube from said ends and discharged from said discharge tube.
